(19) United States
(12) Patent Application Publication
(10) Pub. No.: US 2018/0018658 A1
(43) Pub. Date: Jan. 18, 2018

(54) System and method for processing payment within an application using a mobile device.

(71) Applicant: Thien Pham, Lacey, WA (US)

(72) Inventor: Thien Pham, Lacey, WA (US)

(73) Assignees: Synergex Group, Greenwhich, CT (US); Wayne TAYLOR, Chandler, AZ (US); Pham Holdings, Lacey, WA (US)

(21) Appl. No.: 15/211,697

(22) Filed: Jul. 15, 2016

(51) Int. Cl. G06Q 20/38; G06Q 20/02; G06Q 20/24; G06Q 20/34

(52) U.S. Cl. CPC G06Q 20/385; G06Q 20/34; G06Q 20/027; G06Q 20/24; G06Q 2220/00

(57) ABSTRACT

System and method for processing payment within an application using a mobile device.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to two computer programs that work together to process a payment transaction. The first computer program is the requesting program that runs on any device that is connected to the Internet, such as a Smart TV, laptop computer, desktop computer, mobile device, or similar device. The second program is the paying program that contains a plurality of credit cards. The requesting program starts and creates a transaction request for the user and asks the user to open his/her mobile device and run the paying program. The requesting program waits a certain amount of time before it ends. During such wait time, if the user does not successfully process the payment request, the requesting program timeouts and ends. If the user successfully processes the payment on the paying program, the paying program updates the transaction request to database with the payment gateway payment transaction information, the user's signature, the user's current Global Positioning System (“GPS”) coordinate and status of the transaction request. Once the requesting program knows that there is successful payment transaction information, the requesting program retrieves the transaction request from database and ends.

### BACKGROUND OF THE INVENTION

Entering your credit card information on a website through a web browser to pay for products and services can allow hackers to capture the credit card information via a malware that tracks your keyboard strokes. Once a hacker is able to steal the credit card information, the hacker will then use that information to make payments or withdraw money from banks.

What is needed is a method to securely make payment on a website by using a paying program that runs on a mobile device that has stored plurality of encrypted credit cards.

### BRIEF SUMMARY OF THE INVENTION

In a typical application, a user is at the last step of the checkout process on a website or in an application. The user is requested to enter his/her credit card information to complete the purchase. Once the user clicks a submit button to pay, the program displays instructions to the user to open the paying program on his/her mobile device. The user opens the paying program on his/her mobile device, signs in, enters a payment code to retrieve the transaction request, reviews the transaction request, selects his/her stored encrypted credit card or enter a new credit card, and clicks the submit button to make the payment. Once the payment is successful, the requesting program ends.

### BRIEF DESCRIPTION OF THE SEVERAL VIEWS OF THE DRAWING

FIG. 1 illustrates an exemplary environment for making a payment using a mobile device in a network environment.

FIG. 2 illustrates the method for creating a device request, checking the device request status equal to 1, retrieving the payment transaction information, captured signature, and GPS coordinate from database server.

FIG. 3 illustrates the method for making a payment using the transaction request and updating the database with the payment transaction information, signature captured, and GPS coordinate.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

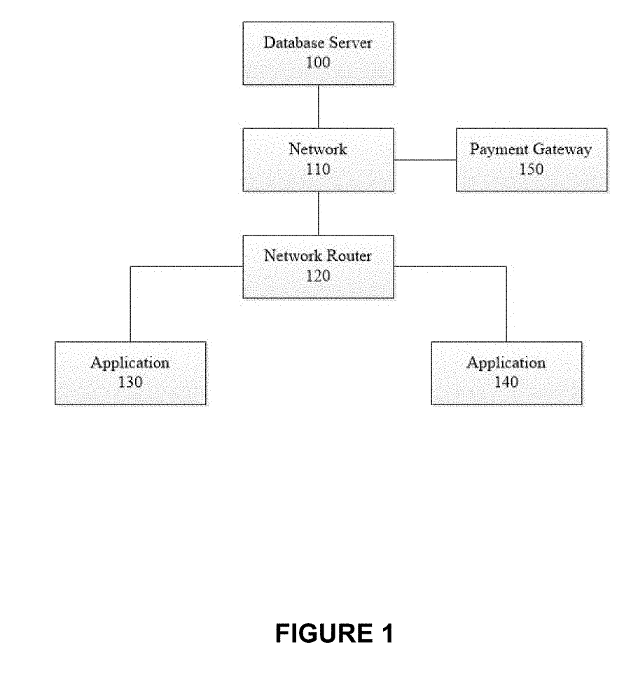

FIG. 1 illustrates an exemplary environment in which the requesting program runs on the device 140. Device 140 is coupled to database server 100 via the network router 120 and the network 110. The paying program runs on device 130 and is coupled to database server 100 via the network router 120 and the network 110. The paying program running on device 130 processes payment transaction by connecting to the payment gateway 150 via the network router 120 and the network 110.

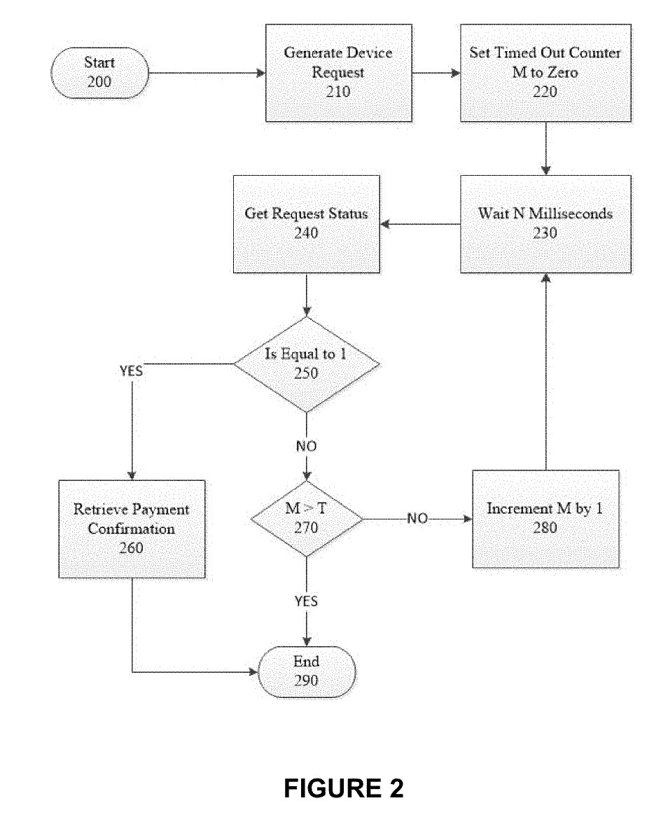

FIG. 2 illustrates the method for creating a device request, checking the device request status equal to 1, retrieving the payment transaction information, captured signature, and GPS coordinate from database server, and ending the program. The program starts at Step 200. The program then continues to Step 210, where the program generates a device request consisting of the current date and time, status of the request, unique payment code, order invoice information, and unique identifier of the device request and stores it to database server 100. The program then continues to Step 220. At Step 220, the program sets the timed out counter M to zero. The program then continues to Step 230. At Step 230, the program waits N milliseconds, where N is greater than or equal to 1. Once the program completes waiting for N milliseconds, the program continues to Step 240. At Step 240, the program connects to database server 100 via the network router 120 and the network 110 to retrieve the device request status of Step 210 using the device request unique identifier of Step 210. The program then continues to Step 250, where it checks the device request status retrieved at Step 240 is equal to 1. If the device request status retrieved at Step 240 is equal to 1, the program continues to Step 260. At Step 260, the program connects to database server 100 via the network router 120 and the network 110 and retrieves the payment information, captured signature, and GPS coordinate that was stored to database server 100 at Step 350 using the device request unique identifier of Step 210, and continues to Step 290. At Step 290, the program ends. If at Step 250, the device request status retrieved at Step 240 is not equal to 1, the program continues to Step 270. At Step 270, the program checks the timed out counter M of Step 220 is greater than T. T is greater than or equal to 1. If M of Step 220 is greater than T, the program continues to Step 290 where the program ends. If at Step 270, M is less than or equal to T, the program continues to Step 280. At Step 280, the program increments M by 1 and continues to Step 230.

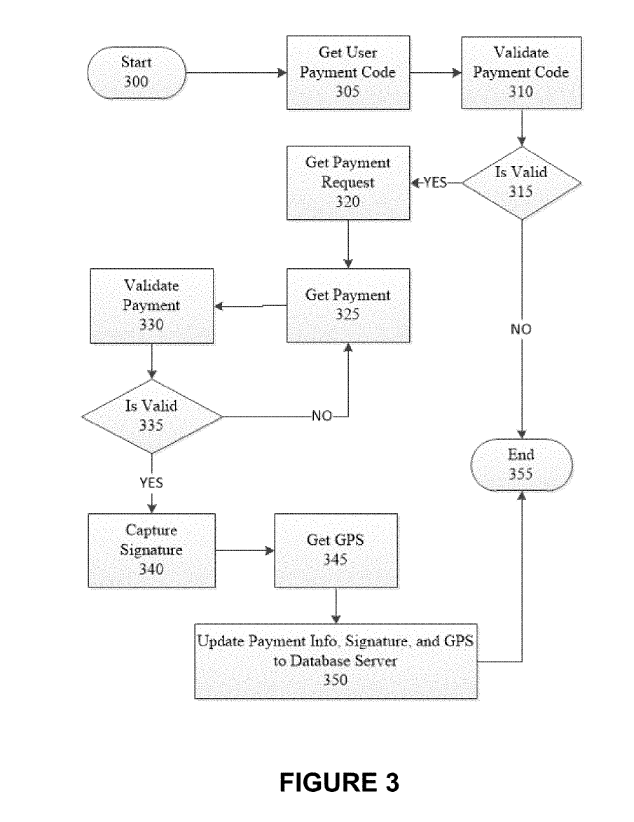

FIG. 3 illustrates the method for making a payment using the transaction request and updating the database with the payment transaction information, captured signature, and GPS coordinate. The paying program on device 130 starts at Step 300 and continues to Step 305. At Step 305, the program requests the user for a payment code. A payment code is an alphanumeric string. Once the user enters the payment code, the program continues to Step 310. At Step 310, the program validates the payment code by connecting to database server 100 via the network router 120 and the network 110 and proceeds to Step 315. At Step 315, if the payment code is valid, the program continues to Step 320. At Step 320, the program connects to database server 100 via the network router 120 and the network 110 and retrieves the payment request using the payment code as the identifier and proceeds to Step 325. At Step 325, the program instructs the user to select a stored encrypted credit card from a list or enter a new credit card. Once the user selects or entered a new credit card, the program proceeds to Step 330. At Step 330, the program connects to the payment gateway 150 via the network router 120 and the network 110 and submits the credit card and order invoice information for processing. The payment gateway 150 processes the credit card and order invoice information and returns the result of the payment transaction to the program. The program then continues to Step 335. At Step 335, if the result of the payment transaction of Step 330 returned by the payment gateway 150 is successful, the program stores the payment transaction information to device memory and proceeds to Step 340. At Step 340, the program asks the user for his/her signature. The user can draw on the device using the movement of a computer mouse, finger, or stylus, or select a digital file from device memory. The program stores the captured signature to device memory and proceeds to Step 345. At Step 345, the program retrieves the GPS coordinate of the device and stores it to device memory and proceeds to Step 350. At Step 350, the program connects to database server 100 via the network router 120 and the network 110 and updates the device request with the payment transaction information stored in device memory at Step 330, the signature captured stored in device memory at Step 340, and the GPS coordinate stored in device memory at Step 345. The program then continues to Step 355 where it ends. If at Step 335, the payment transaction result of Step 330 is unsuccessful, the program proceeds to Step 325.

Several embodiments are specifically illustrated and/or described herein. However, it will be appreciated that modifications and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for processing a payment on a secondary device by generating a device request comprising the steps of:
(a) generating a device request;
(b) storing the generated device request at Step (a) to database server;
(c) checking the device request status equal to 1 using the device request unique identifier at Step (a);
(d) retrieving payment transaction information, captured signature, and GPS coordinate from database server using the generated device request information at Step (a) if the device request status is equal to 1.

2. The method of claim 1, wherein the device request consists of the current date and time, status of the request, unique payment code, order invoice information, and unique identifier.

3. A method for paying on a mobile device comprising the steps of:
(a) retrieving device request using a unique payment code;
(b) storing device request information to device memory;
(c) selecting a stored encrypted credit card from device memory or entering a credit card information;
(d) processing the credit card through a payment gateway using the credit card information at Step (c) and storing the payment transaction information to device memory;
(e) capturing a signature and storing it to device memory;
(f) getting device GPS coordinate and storing it to device memory;
(g) storing the payment transaction information stored in device memory at Step (d), the captured signature stored in device memory at Step (e) and the GPS coordinate stored in device memory at Step (f) to database server.
